(19) United States
(12) Patent Application Publication
(10) Pub. No.: US 2023/0385702 A1
(43) Pub. Date: Nov. 30, 2023

(54) DATA FABRIC FOR INTELLIGENT WEATHER DATA SELECTION

(71) Applicant: Raytheon Company, Waltham, MA (US)

(72) Inventors: Nicole A. Haffke, La Vista, NE (US); Benjamin L. Tarasiewicz, Omaha, NE (US); Philip A. Sallee, South Riding, VA (US); Rachel M. Shafer, Omaha, NE (US); Matthew R. Danielson, Phoenix, AZ (US); Chad W. Lyden, Papillion, NE (US)

(73) Assignee: Raytheon Company, Waltham, MA (US)

(21) Appl. No.: 18/324,763

(22) Filed: May 26, 2023

Related U.S. Application Data
(60) Provisional application No. 63/346,603, filed on May 27, 2022.

(51) Int. Cl. G06N 20/00

(52) U.S. Cl. CPC G06N 20/00

(57) ABSTRACT

A method, comprising: receiving a first data set that is generated by satellite-based instrumentation; processing the first data set to detect an earth event and one or more characteristics of the earth event; and identifying a follow-up action based on the one or more characteristics and executing the follow-up action, wherein the event includes one or more of a weather event, an earth event, or a space event.

### CROSS REFERENCE SECTION

This application claims benefit of U.S. Provisional application No. 63/346,603, filed on May 27, 2022, the entire contents of which are incorporated by reference herein.

### BACKGROUND

Weather is critical to many operations, so predicting accurate weather is very important. More and more weather sensors are becoming available to improve forecasting and that data is being stored in many different data repositories with different formats and access requirements. Forecasters and weather models need access to the right sensor and model data at the right time for the given weather scenario (sometimes with limited bandwidth). They need to be able to use the new weather sensors as they become available and know whether that data will improve the weather models or aid their forecasting/warnings.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the disclosure.

According to aspects of the disclosure, a method is provided, comprising: receiving a first data set; processing the first data set to detect an event and one or more characteristics of the event; and identifying a follow-up action based on the one or more characteristics and executing the follow-up action, wherein the event includes one or more of a weather event, an earth event, or a space event.

According to aspects of the disclosure, a system is provided, comprising: one or more processors configured to perform the operations of: receiving a first data set; processing the first data set to detect an event and one or more characteristics of the event; and identifying a follow-up action based on the one or more characteristics and executing the follow-up action, wherein the event includes one or more of a weather event, an earth event, or a space event.

According to aspects of the disclosure, a non-transitory computer-readable medium is provided that stores one or more processor-executable instructions which, when executed, by one or more processors cause the one or more processors to perform the operations of: receiving a first data set; processing the first data set to detect an event and one or more characteristics of the event; and identifying a follow-up action based on the one or more characteristics and executing the follow-up action, wherein the event includes one or more of a weather event, an earth event, or a space event.

### BRIEF DESCRIPTION OF THE DRAWING FIGURES

Other aspects, features, and advantages of the claimed disclosure will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a weather ontology, according to aspects of the disclosure;

FIG. 2 is a diagram of an example of a metadata model, according to aspects of the disclosure;

FIG. 3 is a diagram of an example of a system, according to aspects of the disclosure;

FIG. 4 is a diagram illustrating aspects of the operation of the system of FIG. 3, according to aspects of the disclosure;

FIG. 5 is a flowchart of an example of a process, according to the present disclosure; and

FIG. 6 is a diagram of an example of a workflow specification.

### DETAILED DESCRIPTION

According to the present disclosure, a system for Intelligent Weather Data Selection is provided that is built on a cloud-friendly containerized data fabric that can run in a container management system, such as Kubernetes. Weather data may be retrieved from multiple different disparate data repositories with different access mechanisms via data gateways within the system. Data may be ingested using the vast array of data decoders developed by the Advanced Weather Interactive Processing System (AWIPS) program of the National Weather Service. As data is ingested, containerized machine learning (ML) applications evaluate the data for broad weather features of interest. As weather features are identified, they are tagged in data for downstream apps. Tagged data triggers human-assisted labeling to provide enhanced intelligent data labeling of more detailed weather features to be used for the development of downstream ML algorithms. As new ML algorithms are developed, they can be tested in a live or simulated AWIPS real-time forecasting environment through interactions with the live data as it is ingested.

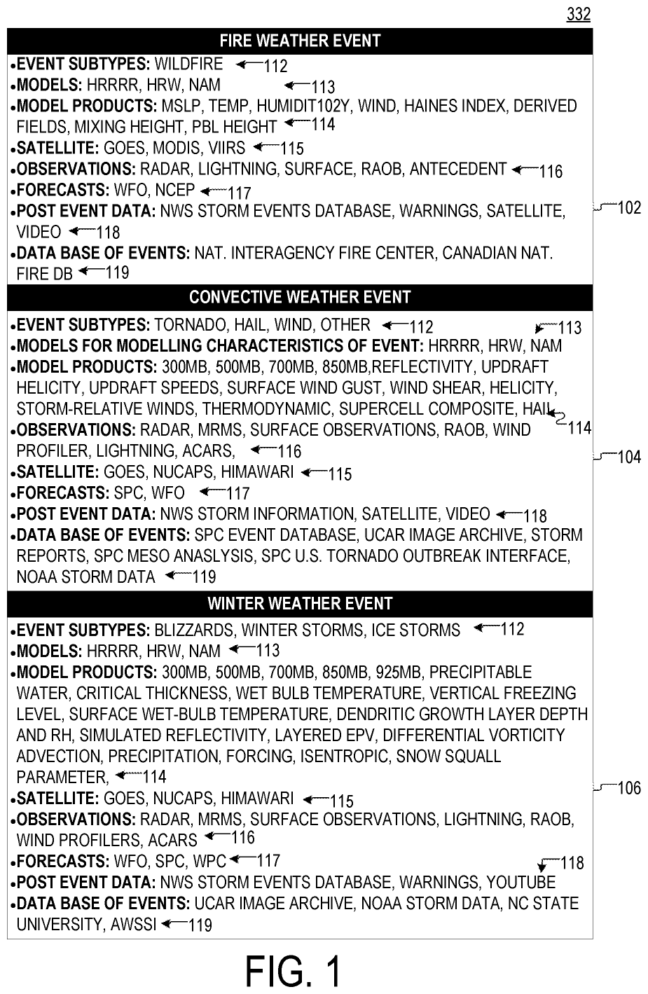

FIG. 1 is a diagram of an example of a weather ontology 332, according to aspects of the disclosure. Ontology 332 may be implemented by using any suitable type of database. The ontology 332 may include records 102-106. Each of the records 102-106 may be associated with a different weather event. Each of the records 102-106 may include information for analyzing the weather event. According to the example of FIG. 1, record 102 is associated with a fire weather event, record 104 is associated with a convective weather event, and record 106 is associated with a winter weather event.

Each of the records 102-106 may include respective portions 112-119. Portion 112 of any of records 102-106 may identify different subtypes of the record's respective weather event. Portion 113 of any of records 102-106 may identify different weather models for analyzing the record's respective weather event. Examples of models that can be used include the High-Resolution Rapid Refresh (HRRR) model, and the North American Mesoscale Forecast System (NAM) model. Portion 114 of any of records 102-106 may identify different model products that can be used to analyze the record's respective weather event. Portion 115 of any of records 102-106 may identify different weather satellites (or specific satellite-based instrumentation) that can be used to obtain data for analyzing the record's respective weather event. Examples of satellites (and/or instrumentation) that can be identified in portion 115 include satellites from the Geostationary Operational Environmental Satellite Network (GOES), satellites with Moderate Resolution Imaging Spectroradiometer (MODIS) instrumentation, and satellites with Visible Infrared Imaging Radiometer Suite (VIIRS) instrumentation, etc. Portion 116 of any of records 102-106 identifies different types of observations that can be obtained for the portion's respective weather event. Portion 117 of any of records 102-106 may identify different types of forecasts that can be obtained for the record's respective event, such as Weather Forecast Office (WFO) forecasts, National Center for Environmental Prediction (NCEP) forecasts, and Weather Prediction Center (WPC) forecasts, etc. Portion 118 of any of records 102-106 may identify different types of post-event data that are associated with the record's respective event. Portion 119 of any of records 102-106 may identify different databases that can be used to obtain information about the record's respective event. It will be understood that the information stored in portions 112-119 is provided as an example only, and the records 102-106 can include any suitable type of information.

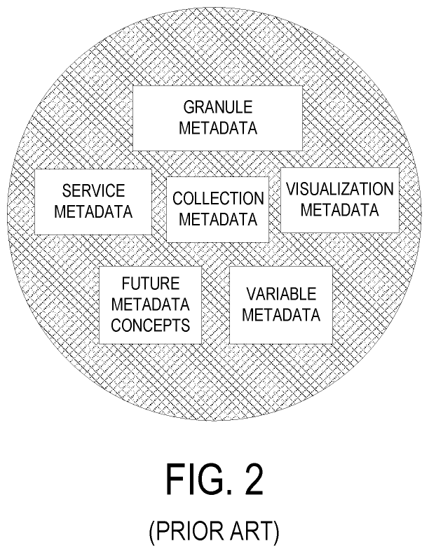

FIG. 2 is a diagram of the NASA Earth data's Common Metadatata Repository Unified Data Model. As illustrated, the model includes service metadata, granule metadata, collection metadata, visualization metadata, and future metadata concepts metadata. FIG. 2 provides examples of different types of metadata, which a dataset can be tagged with. It will be understood that FIG. 2 is provided as an example only, and the present disclosure is not limited to using any specific metadata model to tag metadata sets.

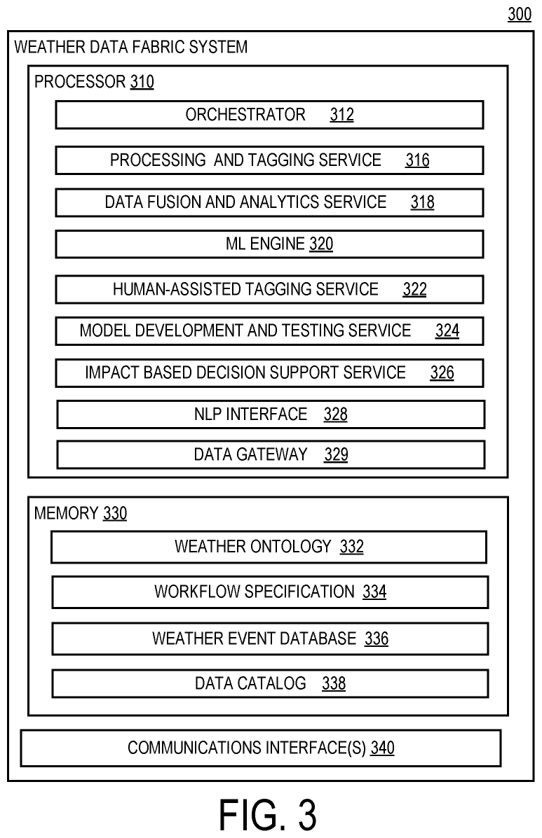

FIG. 3 is a diagram of an example of a system 300, according to aspects of the disclosure. As illustrated the system 300 may include a processor 310, a memory 330, and communications interface(s) 340. The processor 310 may include one or more of a general-purpose processor, a digital signal the processor (DSP), an application-specific integrated circuit (ASIC), a special-purpose processor, a field-programmable gate array (FPGA), and/or any other suitable type of processing circuitry. The memory 330 may include any suitable type of volatile or non-volatile memory, such as an electrically-erasable programmable read-only memory (EEPROM), dynamic random-access memory (DRAM), and/or any other suitable type of memory. The communications interface(s) 340 may include one or more of a radio transceiver, a modem, and/or any other suitable type of communications interface.

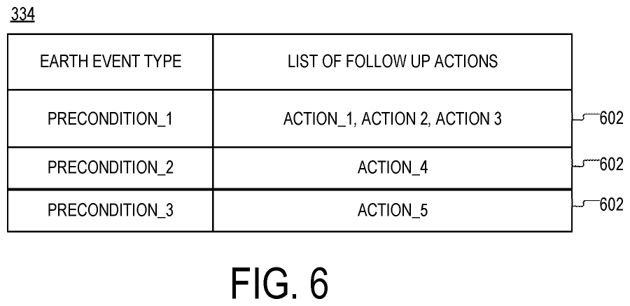

The memory 330 may be configured to store the weather ontology 332, a workflow specification 334, a weather event database 336, and a data catalog 338. The workflow specification 334 may include static or dynamic rules that specify different sets of follow-up actions that can be performed in response to the detection of a particular event or event characteristic. An example of one possible implementation of the workflow specification 334 is discussed further below with respect to FIG. 6. The weather event database 336 may include a database for storing information associated with detected weather events. The data catalog may include information about the data that is available within the weather event database as well as data external to the system that is accessible through the data gateway 329. As used herein, the term database may refer to any suitable type of data structure or software for storing information. The term “database” may refer to a file system folder, a file, a relational database (e.g., SQL), a non-relational database (e.g., MongoDB), and or any other suitable type of database. Although ontology 332 and database 336 are depicted as separate entities, alternative implementations are possible in which they are integrated together.

The processor 310 may be configured to execute an orchestrator 312, services 316-326, natural language processing (NLP) interface 328, and a data gateway 329. The orchestrator 312 may include code for coordinating the execution of services 316-326. The execution of services 316-326 may be performed based on workflow specification 334. In operation, the orchestrator 312 may detect a weather event and spawn one or more follow-up actions based on the weather event and/or information about the weather event. Spawning any of the follow-up actions may include causing one of the services 316-326 to execute, scheduling the execution of any of services 316-326 (e.g., with a scheduler), collecting additional information, reserving satellite bandwidth for the collection of additional information, and or any other suitable action.

The orchestrator 312 may receive a notification from service 316 indicating that service 316 has detected a particular weather event. In addition, the orchestrator 312 may receive, from service 316, a tagged dataset that is associated with the detected event. Next, the orchestrator 312 may assign an identifier corresponding to the detected event. Next, the orchestrator 312 may create a database record corresponding to the identifier and insert the tagged dataset in the database record. As is discussed further below, the tagged dataset may include a dataset that is obtained from a sensor and one or more metadata data tags for the dataset that are generated by the service 316. The metadata tags may be integrated into the dataset or provided separately from the dataset. In instances in which the tags are provided separately, storing the tagged dataset in the database record may include storing both the tags and the dataset in the database record. The database record may be stored in database 336. Next, the orchestrator 312 may insert the tagged dataset in the created database record. Next, the orchestrator 312 may spawn one or more follow-up actions by different ones of services 316-326. Next, the orchestrator 312 may receive data that is generated by the services 316-326 as a result of executing the follow-up actions. And finally, the orchestrator 312 may store the data in the created database record. In some respects, the operations performed by orchestrator 312 may amount to creating a centralized data repository where datasets are indexed according to a particular weather event to which the datasets are related and can be used to analyze. The centralized repository may be used to streamline the work of weather forecasters and other personnel.

Additionally or alternatively, in some implementations, the orchestrator 312 may update the ontology 332 based on information that is received from any of the services 316-326. For example, if the orchestrator 312 receives from the service 324 an indication that a given model can be successfully executed with a new dataset (or type of data), which has not been used previously in conjunction with the model, the orchestrator may update one or more of the records in ontology 332 to identify the new dataset as a possible input to the given model.

Service 316 may be a machine learning (ML) based service for analyzing weather data. The service 316 may employ one or more classifiers that are configured to receive a set of weather data as input and identify one or more weather events that are represented in the set of weather data, as well as characteristics of the events.

In operation, service 316 may receive a data set from a weather sensor. In some implementations, the data set may be an image of a section of the Earth's surface that is generated in space by satellite-based instrumentation. Additionally or alternatively, in some implementations, the data set may be generated by ground-based instrumentation, such as radar, a wind profiler, or radiosonde. The service 316 may then classify the data set using an ML algorithm (e.g., a neural network) to identify a weather event that is represented in the image. In addition, service 316 may tag the weather event with one or more metadata tags that correspond to the weather event. For example, if the dataset indicates that there is a fire event happening in a section of the earth's surface, the service 316 may identify the fire event as such, and optionally process the dataset to obtain additional information about the fire event. The additional information may identify the direction in which the fire is spreading, the speed at which the fire is spreading, the current size of the fire, the location (e.g., coordinates) of the event, etc. Next, the service 316 may generate one or more metadata tags that identify the type of the weather event and/or additional information. Next, the service 316 may tag the dataset with the generated tags. And finally, the service 316 may provide the tagged data set to the orchestrator 312 for storage in the weather event database 336.

As used throughout the disclosure, the phrase “tagging a dataset” shall refer to any action that associates a dataset with one or more metadata tags. For example, tagging the dataset may include inserting the metadata tags into the dataset. As another example, tagging the data set may include creating a database entry that maps the metadata tags to the dataset. As another example, tagging the dataset may include storing the metadata tags in a memory location along with a notification that the metadata tags contain information regarding the dataset. As yet another example, transmitting the metadata tags over a communications network, along with a notification that the metadata tags contain information regarding the dataset.

Service 318 may include analytics software that is used by weather forecasters to retrieve data from different locations. In some implementations, the service 318 may include a graphical user interface (GUI) that permits weather forecasters to view different types of data and annotate them. The service 318 may include tools for manual tagging of data that is presented in the GUI. In addition, service 318 may provide tools for automated data analysis.

The ML engine 320 may be a service configured to execute one or more classifiers for processing sets of weather data. In some implementations, the ML engine 320 may be utilized by the service 318 to provide automated analysis of data. Additionally or alternatively, the ML engine 320 may be used directly by the orchestrator 312 to analyze and tag sets of weather data.

Service 322 may include an ML-based service that uses human input to fine-tune the operation of an ML algorithm (or classifier) on a particular set of data. The ML algorithm may be configured to annotate a dataset by generating one or more metadata tags for the dataset. In some implementations, the service 322 may be configured as discussed in U.S. Pat. No. 11,170,264 entitled Labeling Using Interactive Assisted Segmentation, which is herein incorporated by reference in its entirety.

The service 324 may be configured to execute a machine learning model based on different data sets and assess the relative performance of the model with the datasets. For example, service 324 may execute a weather model based on an initial dataset. Next, service 324 may execute the module based on a baseline dataset. Next, service 324 may compare the performance of the model with the initial dataset and with the baseline dataset to determine if the model performs well with the initial dataset. For example, the model development and testing service may determine a distance between a first value that is generated by the model based on the initial dataset and a second value that is generated by the model based on the baseline dataset. If the distance is greater than or equal to a threshold, the service 324 may determine that the initial dataset is not capable of being used to evaluate the model. If the distance is less than a threshold, the service 324 may determine that the initial dataset is capable of being used to evaluate the model. If service 324 determines that the initial dataset is capable of being used to evaluate the model, the service 324 may store, in ontology 332, an indication that the datasets of the same type as the initial datasets are useful in conjunction with the model. The initial and second data sets may either: (i) be obtained from different sources and include the same type of data or (ii) include different types of data.

An example of a model that can be evaluated with different types of data is the Unified Forecast System (UFS) weather model. The initial data set may be data set that is obtained from TEMPEST-D instrumentation. The baseline dataset may be a dataset that is obtained from Cross-Track Infrared Sounder (CrIS) instrumentation. The initial or baseline dataset may be the one that has been classified by service 316 to detect the presence of unstable atmosphere. The first value (generated by the model based on the initial dataset) may be an estimated time and location of severe weather. The second value (generated by the model based on the baseline dataset) may also be time and location of severe weather. In one aspect, service 324 may be used to expand the functionality of existing models by identifying new types of data that can be used with the models. In another aspect, service 324 may be used to validate the use of the model with new data sources (e.g., weather satellites or weather satellite instrumentation), which have been recently brought online and become useable for weather analysis. In yet another aspect, the service 324 may be used to compare the performance of different models with the initial dataset to determine which model performed best with this dataset.

Additionally or alternatively, the service 324 may be configured to train ML models based on tagged datasets. For example, service 324 may be configured to execute supervised learning algorithms based on the tagged data sets.

Service 326 may include an expert (or human-assisted) system that makes decisions based on information about weather events. For example, service 326 may be configured to obtain information about the weather in a particular area (as indicated by metadata tags for or more weather datasets) and determine whether to perform a particular action. For example, service 326 may decide to stop all flights in an area where a severe snowstorm is present. Service 326 may include any suitable type of software that relies on tagged weather data for its operation. The NLP interface 328 may be configured to receive an unstructured query from the orchestrator 312 and convert it to a structured query. The structured query may be compliant with the syntax of a particular database. Interface 328 may use the structured query to retrieve the data set. The interface 328 may return the retrieved data set to the orchestrator 312 or provide it directly to one of the services 316-322 for tagging.

The data gateway 329 may include a data adapter for retrieving data from different data sources. The data sources may include a satellite, a database, and/or any other suitable type of data source.

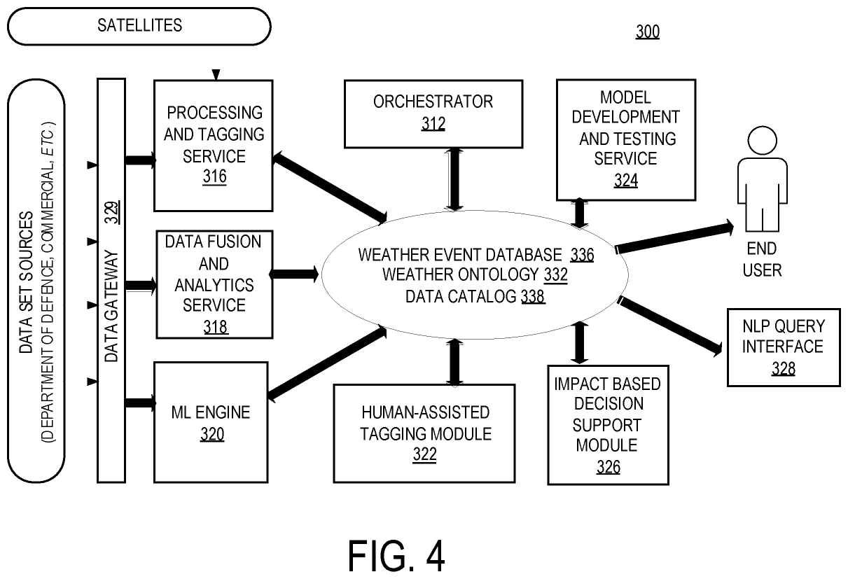

FIG. 4 is a schematic diagram illustrating aspects of the operation of the system 300, according to aspects of the disclosure.

In another aspect, the system 300 may receive an initial dataset, detect an initial weather event (by using service 316), collect additional data that is associated with the initial dataset, and store the collected data in a centralized location. The additional data may include any data that is associated with the weather data. The additional data may include images of the weather event or images of related weather events. Under the nomenclature of the present disclosure, a set of additional data is also referred to as a “follow-up dataset”. In one example, a related weather event may be an event that is created or affected by the initial event. A related weather event may be an event whose images can be useful in analyzing the initial event or a broader pattern of weather events of which the initial event is part. The centralized location may include the weather event database 336 and weather ontology 332. The weather event database 336 may store images of the weather event. The images may be tagged by different ones of services 316-322. The tagged images may be used by weather forecasters and other personnel to understand the state of the weather event, make predictions about the weather event, and/or make public safety decisions regarding the weather event. As used throughout the disclosure, the term image may refer to a dataset that is provided by a weather (or earth) sensor. The image may include a single data frame or multiple data frames. The weather (or earth) sensor may include satellite-based instrumentation or land-based instrumentation.

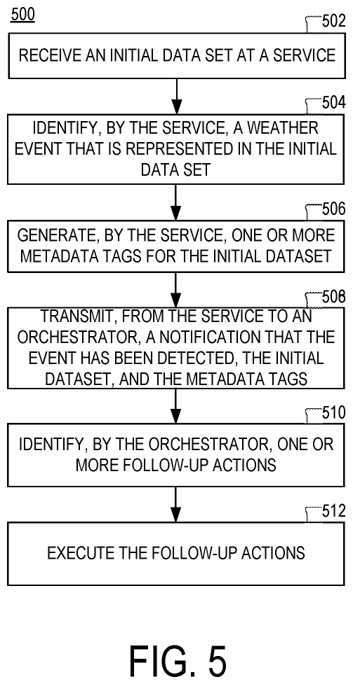

FIG. 5 is a flowchart of an example of a process 500, that is performed by the system 300. At step 502, service 316 receives an initial dataset. As noted above, the initial dataset may be an image of a section of the earth (or earth surface) that is taken by a weather satellite (or a satellite-based sensor) or another type of sensor (e.g., a ground-based sensor). At step 504, service 316 identifies a weather event that is represented in the initial data set. Under the nomenclature of the present disclosure, the identified weather event is also referred to as an additional weather event. At step 506, service 316 processes the initial dataset to generate one or more metadata tags for the initial dataset. At step 508, service 316 transmits, to the orchestrator 312, a notification that the weather event has been detected, the initial dataset, and the metadata tags. At step 510, the orchestrator 312 identifies one or more follow-up actions. At step 512 the orchestrator 312 executes the follow-up actions. In one implementation, executing any of the follow-up actions may include transmitting to one of services 316-326 an instruction to perform the follow-up action. The phrase “executing a follow-up action” may refer to one or more of: (i) executing the follow-up action, (ii) causing the follow-up action to be performed by another entity, or (iii) triggering the performance of the follow-up action.

An example of a first follow-up action may include sending an area of regard (AOR) request for the collection of an additional dataset that is associated with the weather event (detected at step 504). The area of regard (AOR) request may be sent to a satellite or a satellite control facility. The AOR request may request the collection of a follow-up data set that has greater resolution than the initial dataset. The follow-up data set may be an image of a section of the earth at the location where the weather event is detected (at step 504). In some implementations, the AOR request may identify the location of the weather event as the location of which an image is requested. Executing the first follow-up action may include transmitting the AOR request to a satellite or satellite management facility, or another command-and-control center that may influence collection of follow-up data on demand through dispatch of available assets such as aerial vehicles, vehicle mounted weather radar or sensor systems, receiving the follow-up data set in response to the AOR request, and storing the follow-up data set in a predetermined location (e.g., the database 336). In addition, a follow-up dataset may include a photographic image or video of a weather event or its aftermath, and/or other data that is obtained from the weather event database 336 or another repository or cloud service. Although in the present example the follow-up dataset has a different resolution from the initial dataset, alternative implementations are possible in which the follow-up dataset and the initial dataset differ in another characteristic. For example, the initial data set and the follow-up dataset may be generated by different types of sensors, and they may include different types of data to give a better picture of the same weather event. As another example, the follow-up data set may be taken from a different angle than the initial dataset. As yet another example, the follow-up dataset and the initial dataset may measure different weather event characteristics, etc.

An example of a second follow-up action may include detecting whether the initial dataset (or another dataset) is capable of being used as input to a model corresponding to the weather event (detected at step 504). Executing the follow-up action may include transmitting, to service 324, a request to perform the second follow-up action. The second-follow up action may be performed in the manner discussed above with respect to FIG. 3. In response to executing the follow-up action, the orchestrator 312 may receive from service 324 an indication of whether the initial dataset (or the other dataset) is capable of being used to evaluate the model. If the indication shows that the initial (or other) dataset is capable of being used to evaluate the model, the orchestrator 312 may store the indication in one or more records of the ontology 332.

An example of a third follow-up action includes performing a human-assisted analysis of the initial dataset. Executing the third follow-up action may include transmitting to the service 332 (or another entity) a request to perform (or schedule) a human-assisted analysis of the initial data set. In response to the request, the orchestrator 312 may receive a copy of the initial dataset that is annotated by a human and/or one or more metadata tags that are generated based on keyboard or mouse input by the human.

An example of a fourth follow-up action includes designating the initial dataset, along with the metadata generated at step 506, as training data for a model corresponding to the weather event (detected at step 504). Executing the fourth follow-up action may include causing the service 324 to use the initial data set (e.g., in combination with the tags) to train the corresponding model. For example, causing the service 324 may include transmitting to the service 324 the initial dataset and the metadata tags and instructing the service 324 to execute an algorithm for training the model based at least in part on the initial dataset and the metadata tags.

An example of a fifth follow-up action includes reserving additional satellite bandwidth. The additional satellite bandwidth may be used to obtain additional images of the weather event (detected at step 504) or related weather events. Executing the fifth follow-up action may include one or more: (i) identifying a first location of the earth's surface where the weather event is taking place, (ii) selecting a second location based on the first location, (iii) identifying a satellite that would be in a position to observe the second location during a predetermined time period, (iv) transmitting, to a satellite control facility, a request to reserve bandwidth of the satellite when the satellite is passing over (or otherwise able to observe) the second location. In some implementations, the second location may be the same as the first location. Additionally or alternatively, the second location may be adjacent to the first location.

An example of a sixth follow-up action includes instructing a radar to take additional radar scans. The radar may be used to obtain additional images of the weather event (detected at step 504) or related weather events. Executing the sixth follow-up action may include one or more: (i) identifying a first location of the earth's surface where the weather event is taking place, (ii) selecting a second location based on the first location, (iii) identifying a radar that is able to observe the first location during a predetermined time period, (iv) transmitting, to the identified radar, a request to capture images of the first or second location. In some implementations, the second location may be the same as the first location. Additionally or alternatively, the second location may be adjacent to the first location. In other words, another follow up action may be to command a radar to focus in certain location and take additional radar scans of a particular location very similarly to the satellite of the fifth follow-up action example. The radar may be on the ground in a fixed location or on an aircraft or vehicle.

An example of a seventh follow-up action may include retrieving an additional dataset that is associated with the weather event (identified at step 504), tagging the additional dataset with one of services 316, 318, 320, and 322. Tagging the additional dataset may include annotating the dataset by generating one or more metadata tags for the additional dataset. Additionally or alternatively, the seventh follow-up action may further include executing the service 324 to determine whether the additional dataset may be used to evaluate a particular model corresponding to the weather event that is detected at step 504. Additionally or alternatively, the seventh follow-up action may further include causing the service 324 to train the particular model based on the additional dataset and/or metadata tags for the dataset.

FIG. 6 shows an example of one possible implementation of the workflow specification 334. As illustrated, the workflow specification 334 may include a plurality of entries 602. Each entry 602 may identify: (i) a precondition, and (ii) a list of follow-up actions that need to be executed by the orchestrator 312 when the precondition holds true. The pre-condition of any entry 602 may be evaluated based on one or more characteristics of the initial dataset (obtained at step 502). For example, a precondition may hold true when the weather event (detected at step 502) is of a particular type or subtype (e.g., it may hold true when the detected weather event is any winter event or a snowstorm specifically. As another example, a precondition may hold true when the weather event (detected at step 502) possesses a particular characteristic. For example, a precondition may hold true when the land area affected by the weather event (detected at step 502) exceeds a predetermined size, such as 20 sq. km. As yet another example, a precondition may hold true if the intensity of the weather event (detected at step 502) is Level 3 or higher. In some respects, any of the preconditions in the workflow specification 334 may be based on the type or another characteristic of the weather event (detected at step 504). The type or other characteristics of the weather event may be identified by the orchestrator 312 based on metadata tags for the initial dataset (obtained at step 502), which are provided to the orchestrator 312 by the service 316.

When the precondition of one of the entries 602 holds true, the follow-up actions that are identified by the same entry are executed. The follow-up actions are identified by the list of follow-up actions which is part of the entry. The list of follow-up actions may identify one or more follow-up actions. Specifically, the list of follow-up actions may include one or more follow-up action definitions. The definition for any given follow-up action may identify the service that is going to perform the follow-up action. Optionally, the definition for the given follow-up action may include an opcode for the follow-up action. Optionally, the definition for the given follow-up action may identify a dataset that would be provided to the service executing the follow-up action and used as a basis for executing the follow-up action (e.g., the initial dataset obtained at step 502 or another dataset obtained as a result of executing another follow-up action). Optionally, the definition for the given follow-up action may specify an action that is going to be performed (by the orchestrator 312) on data that is returned as a result of executing the follow-up action. For example, the definition may identify an identifier of a record in the database 336 where the data is desired to be stored by the orchestrator 312. Optionally, when the follow-up action includes the retrieval of an additional dataset, the definition of the given follow-up action may identify a specific satellite (or database) from which the additional dataset is going to be obtained or specific instrumentation that would be used to generate the dataset (e.g., radar, VIIRS, radiosonde, etc).

According to the present disclosure, each of modules 312-330 is a service that is executed in a containerized platform, such as Kubernetes. However, alternative implementations are possible in which any of the modules 312-330 is implemented in a different manner. For example, in some implementations, each of the modules 312-330 may be a standalone application. As another example, in some implementations, any two or more of the modules 312-330 may be part of the same standalone application. As used herein, the term “service” refers to one or more processor-executable instructions (and/or electronic circuitry) that are configured to perform an action. The phrase “transmitting, to a service, a request to perform an action” may refer to the transmittal of a message to perform the action, making an API call, and/or any other suitable action.

FIGS. 1-6 are provided as an example only. At least some of the steps discussed with respect to FIGS. 1-6 may be performed in parallel, in a different order, or altogether omitted. As used in this application, the word “exemplary” is used herein to mean serving as an example, instance, or illustration. The concepts and ideas provided through the disclosure are not limited to weather events, and they are applicable to any suitable type of earth events and/or space events. Examples of earth events include, weather events (e.g., fire events, convective events, flooding events, winter events, etc.), earthquakes, volcano eruptions, toxic gas release, tsunami events, clear skies events, etc. The term metadata tag as used throughout the disclosure shall refer to any number, string, or alphanumerical string that is at least in part indicative of a characteristic of a weather/earth event. The terms “label” and “metadata tag” are used interchangeably throughout the disclosure.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the disclosure and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range. The phrase “field indicative of location” as used throughout the application shall refer to a field that is partially or wholly indicative of the location. By way of example, and without limitation, the phrase “protocol data unit (PDU) for controlling a connection between a communications device and a wireless communications network” may refer to a protocol unit that contains information that is usable by the communications network to change the state of an existing connection to the communications network and/or initiate a new connection, etc.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed disclosure. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed disclosure. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed disclosure.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed disclosure might be made by those skilled in the art without departing from the scope of the following claims.

1. A method, comprising:
receiving a first data set;
processing the first data set to detect an event and one or more characteristics of the event; and
identifying a follow-up action based on the one or more characteristics and executing the follow-up action,
wherein the event includes one or more of a weather event, an earth event, or a space event.

2. The method of claim 1, wherein the follow-up action is identified by using one or more data structures that map each of a plurality of preconditions to a respective set of one or more follow-up actions, each of the preconditions being based on at least one of the detected characteristics of the event.

3. The method of claim 1, wherein:
the follow-up action includes presenting options for additional data to a user; and
executing the follow-up action includes retrieving a second data set in response to a selection by the user of one of the options.

4. The method of claim 1, wherein the follow-up action incudes determining whether the first data set is capable of being used to evaluate a model corresponding to the event, the determining including generating a result value by evaluating the model based on the first data set and detecting whether the result value satisfies a predetermined condition.

5. The method of claim 1, wherein the follow-up action includes generating a request to perform human-assisted tagging of the first data set and transmitting the request to at least one of a utility for performing a human-assisted tagging of the first data set, and/or a scheduler for scheduling the human-assisted tagging of the first data set.

6. The method of claim 1, wherein the follow-up action includes identifying a second location based on a first location of the event, selecting a radar that is configured to observe the second location, and transmitting a request to the radar to provide one or more images of the second location.

7. The method of claim 1, wherein the follow-up action includes training a machine learning model based on the first data set or performing further analysis on the initial data set.

8. A system, comprising:
one or more processors configured to perform the operations of:
receiving a first data set;
processing the first data set to detect an event and one or more characteristics of the event; and
identifying a follow-up action based on the one or more characteristics and executing the follow-up action,
wherein the event includes one or more of a weather event, an earth event, or a space event.

9. The system of claim 8, wherein the follow-up action is identified by using one or more data structures that map each of a plurality of preconditions to a respective set of one or more follow-up actions, each of the preconditions being based on at least one of the detected characteristics of the event.

10. The system of claim 8, wherein:
the follow-up action includes transmitting an area of regard (AOR) request for a collection of a second data set of the event, and
executing the follow-up action includes retrieving the second data set and associating the second data set with the first data set.

11. The system of claim 8, wherein the follow-up action incudes determining whether the first data set is capable of being used to evaluate a model corresponding to the event, the determining including generating a result value by evaluating the model based on the first data set and detecting whether the result value satisfies a predetermined condition.

12. The system of claim 8, wherein the follow-up action includes generating a request to perform human-assisted tagging of the first data set and transmitting the request to at least one of a utility for performing a human-assisted tagging of the first data set, and/or a scheduler for scheduling the human-assisted tagging of the first data set.

13. The system of claim 8, wherein the follow-up action includes identifying a second location based on a first location of the event, selecting a satellite that is configured to observe the second location, and transmitting a request to reserve bandwidth of the satellite during a period in which the second location is going to be observable by the satellite.

14. The system of claim 8, wherein the follow-up action includes training a machine learning model based on the first data set or performing further analysis on the first data set.

15. A non-transitory computer-readable medium storing one or more processor-executable instructions which, when executed, by one or more processors cause the one or more processors to perform the operations of:
receiving a first data set;
processing the first data set to detect an event and one or more characteristics of the event; and
identifying a follow-up action based on the one or more characteristics and executing the follow-up action,
wherein the event includes one or more of a weather event, an earth event, or a space event.

16. The non-transitory computer-readable medium of claim 15, wherein the follow-up action is identified by using one or more data structures that map each of a plurality of preconditions to a respective set of one or more follow-up actions, each of the preconditions being based on at least one of the detected characteristics of the event.

17. The non-transitory computer-readable medium of claim 15, wherein:
the follow-up action includes transmitting an area of regard (AOR) request for a collection of a second data set of the event, and
executing the follow-up action includes retrieving the second data set and associating the second data set with the first data set.

18. The non-transitory computer-readable medium of claim 15, wherein the follow-up action incudes determining whether the first data set is capable of being used to evaluate a model corresponding to the event, the determining including generating a result value by evaluating the model based on the first data set and detecting whether the result value satisfies a predetermined condition.

19. The non-transitory computer-readable medium of claim 15, wherein the follow-up action includes generating a request to perform human-assisted tagging of the first data set and transmitting the request to at least one of a utility for performing a human-assisted tagging of the first data set, and/or a scheduler for scheduling the human-assisted tagging of the first data set.

20. The non-transitory computer-readable medium of claim 15, wherein the follow-up action includes identifying a second location based on a first location of the event, selecting a satellite that is configured to observe the second location, and transmitting a request to reserve bandwidth of the satellite during a period in which the second location is going to be observable by the satellite.
